(19) United States
(12) Patent Application Publication
(10) Pub. No.: US 2006/0011078 A1
(43) Pub. Date: Jan. 19, 2006

(54) Delivery device on a sheet processing machine

(75) Inventors: Ulrich Beitel, Sulzbach (DE); Eckhard Braun, Leipziger Ring (DE); Rolf Martin Lange, Von-Behring-Strasse (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: MAN Roland Druckmaschined AG, Offenbach (DE)

(21) Appl. No.: 10/515,137

(22) PCT Filed: May 2, 2003
(86) PCT No.: PCT/EP03/04631

§ 371 Date: Jul. 18, 2005

(30) Foreign Application Priority Data
May 17, 2002 (DE) 102 22 545.1

(51) Int. Cl. B04C 7/00; B41F 13/24; B65H 39/10

(52) U.S. Cl. 101/232; 271/300

(57) ABSTRACT

The invention pertains to a delivery unit on a sheet-fed processing machine, preferably a sheet-fed printing or sheet-fed varnishing machine. The aim of the invention is to provide a delivery unit of this type such that permits in-line transport of printed and/or varnished sheets to at least one additional production line. To this end, the delivery unit 1 includes an endless revolving sheet conveyor system 5 that conveys the sheets to a first delivery stack 9 and a sheet withdrawal drum 7 that functions as a diverter for transferring sheets to a second stacking system. The sheet withdrawal drum is arranged upstream of this delivery stack relative to the conveying direction. A sheet transport system 20 is arranged downstream of the drum 7 and a folding module 12 is arranged downstream of the sheet transport system in the rotational direction 10 of the drum.

### FIELD OF THE INVENTION

The invention pertains to a delivery unit for a sheet-fed processing machine. The delivery unit is preferably applicable to sheet-fed printing and/or sheet-fed varnishing machines.

### BACKGROUND OF THE INVENTION

A type of delivery unit for rotary sheet-fed printing machines is disclosed in DE 24 30 212 A1. This delivery unit contains a sorting device that selectively deposits the printed sheets on two delivery stacks as a function of a measurement related quality control carried out within the printing machine. A revolving first chain conveyor transports the printed sheets to a first delivery stack. The first chain conveyor is associated with a withdrawal drum having gripper systems. A second chain conveyor is arranged downstream of the withdrawal drum. The printed sheets are deposited on the first or the second delivery stack depending on the determined quality.

DE 198 19 491 C1 discloses a sheet delivery unit for a rotary printing machine having an endless revolving conveyor system that transports the sheets to a first delivery stack. A drum that functions as a diverter and comprises at least one gripper system is arranged upstream of the delivery stack. The drum is operable to selectively or continuously withdraw sheets and is assigned to the lower strand of the conveyor system. Another stacking system is situated adjacent to and assigned to the drum for depositing sheets. A sheet guiding device with a recess that extends over the format width is arranged outside the lower strand. The orbit of the drum's gripper system intersects the recess, and the second stacking system is arranged approximately underneath the drum. The second stacking system may be configured in the form of a pallet or a skeleton container, for example, for receiving waste sheets, as well as in the form of a stacking system with stop elements and aligning devices in order to produce exact stacks.

Another delivery unit for a rotary sheet-fed printing machine is disclosed in DE 43 22 324 A1. This delivery unit has, among other characteristics, a modular design. For example, a dryer section is arranged within the delivery unit in the form of a module. The delivery unit is also assigned a copy diverter that is modularly arranged downstream of the last chain wheel of the sheet conveyor system in the conveying direction. Waste sheets as well as test sheets can be stacked separately outside the main stack by activating the gate.

DE 195 23 881 A1 discloses a rotary printing machine with a delivery unit and revolving conveyor means. An additional processing unit with cylinders for guiding the sheets or products is arranged downstream of the delivery unit in the conveying direction. Folding processes can be carried out during transport of the sheets/products. For this purpose, at least one folding module is arranged downstream of the delivery unit in the conveying direction. One of the folding modules is integrated into the transport path of the revolving conveyor means.

One disadvantage of the two latter-mentioned designs is that the subassemblies arranged downstream of the sheet conveyor systems, e.g., the copy diverter and the stack or the folding modules for additional processing arranged downstream of the conveyor systems, inevitably lead to an increased length of the processing machine.

### BRIEF SUMMARY OF THE INVENTION

In view of the foregoing, an object of the present invention is developing a delivery unit for a sheet-fed processing machine in which the aforementioned disadvantages are eliminated and in particular, an in-line transport of the printed and/or varnished sheets to at least one additional production line is possible.

A first advantage is obtained in that the printed and/or varnished sheets can be selectively deposited on a first delivery stack or—when activating a drum that functions as a diverter—on a second delivery stack. Alternatively, the printed and/or varnished sheets can be transported to a folding module with at least one downstream folding apparatus.

It is also advantageous if the second stacking system can be utilized as an auxiliary stacking device in a non-stop mode. When a stack exchange needs to be carried out on the first delivery stack, a sheet transport interruption is produced by means of the drum that functions as a diverter in order to prevent a possible collision between the arriving sheets and the non-stop device to be inserted. This operating mode improves the process stability during depositing of the sheets on the first delivery stack. The production printing speed can be maintained during depositing of the sheets on the first delivery stack. The depositing of sheets with color variations as well as start-up sheets, etc., on the first delivery stack can be prevented by previously sorting out and depositing these sheets on the second delivery stack.

Another advantage is that the delivery unit can be universally utilized if it is coupled to a folding module with at least one folding apparatus. This means that an intermediate storage of the sheets is no longer required and that commercial products of variable format can be produced.

The folding apparatus(es) can be coupled to the delivery unit, particularly to a drum that sorts out the sheets, in the form of a folding module. It should be possible to laterally slide one such folding module into and out of the delivery unit in accordance with the draw out-unit design.

The folding apparatuses are preferably configured in accordance with the buckle fold principle; alternatively, it is also possible to configure the folding apparatus in accordance with the knife fold principle or a combination of both principles. Since the material to be printed is already present in the form of sheets, it is no longer necessary to utilize a cross cutter in the delivery unit.

It is also advantageous if the delivery unit can be utilized in an operating mode that serves exclusively for the production of folded sheets by utilizing a drum that functions as a diverter. In addition, the first delivery stack can be utilized for waste sheet or test sheet delivery, for example, by briefly deactivating the drum. The delivery unit can still be utilized for delivery of unfolded sheets to a first delivery stack while the drum is inactive.

### BRIEF DESCRIPTION OF THE DRAWING

FIG. 1 is a side view of an illustrative delivery unit according to the invention having a first and a second stacking system and a folding module.

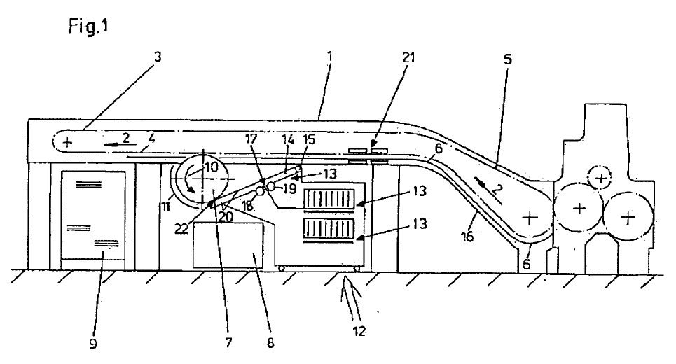

### DETAILED DESCRIPTION OF THE INVENTION

A delivery unit 1 is arranged in a sheet-fed rotary processing machine downstream of a printing unit or a varnishing unit in the conveying direction 2 of the sheets to be deposited. The delivery unit 1 consists, among other things, of an endless revolving sheet conveyor system 5 with several gripper systems fixed thereon. The sheet conveyor system 5 is preferably configured as a chain conveyor with upper and lower strands 3, 4. The sheet conveyor system 5 conveys printed and/or varnished sheets to a first delivery stack 9 (main stacking system) and deposits the sheets thereon.

A sheet guiding device 6 that preferably can be actuated pneumatically is assigned to and spaced apart by a short distance from the lower strand 4 of the sheet conveyor system 5. A recess that extends over the format width is arranged in the sheet guiding device 6 outside the lower strand 4 and spaced apart from the sheet conveyor system 5 by a short distance. In the area of the recess, a drum 7 for guiding the sheets is assigned to and arranged underneath the lower strand 4. The outer surface of the drum 7 is provided with at least one gripper system, the orbit of which intersects the recess. A second stacking system 8 is preferably arranged approximately underneath the drum 7 for the depositing of sheets.

The sheet conveyor system 5 extends as far as a point above the first delivery stack 9 that functions as the main stack. Relative to the conveying direction 2, the drum 7 for guiding the sheets is assigned to the sheet conveyor system 5 upstream of the first delivery stack 9. Dryer systems 21 (UV dryer, IR dryer or other systems) are preferably arranged upstream of this drum 7 in the conveying direction 2. In addition, measuring devices for quality control of the sheets are arranged upstream of this drum 7, for example, on the last printing/varnishing unit.

Relative to a single format rubber blanket cylinder or plate cylinder, it is preferable to configure the drum 7 as a double format drum 7 with two gripper systems symmetrically arranged on the outer surface. However, it would also be possible to configure the drum 7 with a single format diameter and one gripper system or with a multiple format diameter and a corresponding number of gripper systems symmetrically distributed over the circumference.

The drum 7 functions as a diverter for selectively or continuously withdrawing sheets from the flow of sheets being conveyed by the sheet conveyor system 5 that revolves in the direction of the first delivery stack 9. For this purpose, the drum 7 is preferably assigned to a horizontally arranged section of the sheet conveyor system 5. Relative to the rotational direction 10 of the drum 7, a sheet guide 11, which is preferably coupled to a pneumatic system, is arranged in the sheet delivery at a defined distance from the orbit of the gripper systems.

In a first variation, the sheet being guided on the drum 7 is deposited on the second stacking system 8. The second stacking system 8 may simply be configured as a pallet or skeleton container for receiving waste sheets. Alternatively, stop elements and aligning devices may be provided in order to exactly align the edges of the sheets forming a stack.

In another variation, a folding module 12 is arranged downstream of the drum 7 relative to the drum's rotational direction 10. In this respect, it is possible to slide the folding module 12 into and out of the delivery unit 1 in accordance with the draw out-unit design.

Preferably, the folding module 12 slides laterally relative to the conveying direction 2 of the sheets. In one particularly preferred embodiment, it is possible to slide the folding module 12 into and out of the delivery unit 1 on its B-side. For this purpose, the folding module 12 preferably can be displaced by means of linear guides or is provided with lock-type rollers.

In a first operating mode, the second stacking system 8 remains in the delivery unit 1 and serves to receive sheets that are not delivered to the folding module 12 by the drum 7. These sheets can consist, for example, of waste sheets produced during start-up of the processing machine. The second stacking system 8 is then deactivated, and the sheets are delivered to the folding module 12 by the drum 7. In a second operating mode, the second stacking system 8 can be deactivated in the delivery unit 1 or removed from the delivery unit 1 such that the sheets are exclusively delivered to the folding module 12 by the drum 7. When the second stacking system 8 is deactivated or removed, the first delivery stack 9 can be utilized for the depositing of sheets if, for example, waste sheets are produced.

Relative to the rotational direction 10, sheet transport system 20, for example, a conveyor belt system, is preferably arranged downstream of the drum 7. The folding module 12, which comprises at least one folding apparatus 13, is arranged downstream of the sheet transport system 20.

The sheet transport system 20 can compare, for example, of a driven conveyor belt system with an endless belt that forms an upper and a lower strand and serves for friction-held sheet transport. In this case, the transport direction of the conveyor belt system is directed opposite to the conveying direction 2 of the sheet conveyor system 5 situated above the conveyor belt system.

A guide element 22 is preferably arranged parallel to the axis of the drum 7 in order to guide the sheets between the drum 7 and the sheet transport system 20, with this guide element promoting the process of “peeling” the sheet off the drum. At the same time, the guide element 22 serves to guide the respective sheets released from the gripper system of the drum 7 to the sheet transport system 20. The guide element 22 is preferably provided with comb-shaped tines pointed in the direction of the outer surface of the drum 7. The guide element is arranged a short distance from the drum 7 such that the grippers of the drum 7 are able to pass through the intermediate spaces between the tines of the stripping element 22. The cone-shaped tines transform into a guide surface for guiding the sheets in the direction of the sheet transport system 20.

The front part of the guide element 22 is tapered in the direction of the drum 7, preferably in a wedge-shaped fashion, with the guide surface for guiding the sheets preferably being arranged adjacent to the taper in the direction of the sheet transport means 20. In this case, the comb-shaped tines may also have in a tapered configuration system.

In another variation, the guide element 22 consists of a flow channel that is arranged parallel to the axis of the drum 7 and coupled to a pneumatic system, with the flow channel being configuration with tines can that transform into the guide surface. The guide surface and/or the tines contain openings for discharging blasting air in order to promote the process of “peeling” the sheets off the drum 7, as well as that of transfer to the downstream sheet transport system 20.

In another variation, the drum 7 for guiding the sheets is coupled, for example, to a pneumatic system via a rotary pneumatic connection in the axial center. This provides the drum 7 with an air-permeable outer surface such that it can be operated as a drum 7 that carries the sheets on an air cushion. Alternatively, several nozzles that can be actuated pneumatically and/or mechanical actuator (for example, lifters) can be arranged on the drum 7 in the area of the grippers in order to promote the separation of the front edge of the respective sheet from the drum 7 for the additional transport in the direction of the sheet transport system 20.

The folding module 12 contains at least one folding apparatus 13. Each folding apparatus 13 may be configured in accordance with the buckle fold principle, the knife fold principle or a combination thereof.

A folding apparatus 13 of this type contains an adjustable stop 15 that preferably can be adjusted to variable formats and is arranged underneath the sheet conveyor system 5 in the direction of an ascending delivery section 16. At least a first and a second folding roller 18, 19, which preferably extend over the maximum format width of the sheet material and can be driven in opposite directions, are arranged in a buckle-folding chamber 17.

If the folding module 12 contains only one folding apparatus 13, a folded sheet delivery or a folded sheet stacker is arranged downstream of the folding rollers 18, 19 in order to laterally transport the sheets out of the delivery unit 1 in the horizontal position or standing vertically on a fold.

If the folding module 12 contains several folding apparatuses 13, a second, and if applicable, an additional folding apparatus 13 are arranged downstream of the first folding apparatus 13, wherein the folded sheet delivery or the folded sheet stacker is arranged downstream of the last folding apparatus 13.

An exemplary embodiment of the invention including a first folding apparatus 13 that is configured in accordance with the buckle fold principle is described in greater detail below. Relative to the rotational direction 10, the guide element 22 as well as the sheet transport system 20 are arranged downstream of the drum 7. At least two folding rollers 18, 19 that extend over the maximum format width of the sheet material and can be driven in opposite directions are arranged downstream of the sheet transport system 20 in the buckle-folding chamber 17. Relative to the transport direction of the sheet transport means 20, a folding pocket 14 is arranged downstream of the folding rollers 18, 19. A stop 15 is arranged within the folding pocket 14 such that it can be variably positioned according to the sheet format. After the first fold is produced, the sheets may, if so required, be transported to at least one additional folding apparatus 13. For example, a cross fold can be produced in the first folding apparatus 13 and a longitudinal fold can be produced in the downstream second folding apparatus 13, preferably in accordance with the knife fold principle. A third folding apparatus 13 that is realized, for example, in accordance with the knife fold principle is arranged downstream of the second folding apparatus 13. Another longitudinal fold is produced in the third folding apparatus 13. The folded products thus produced can be transported out of the delivery unit 1 laterally to the conveying direction 2 in overlapping form or preferably standing on a fold.

The folding module 12 is coupled to the machine controller of the sheet-fed processing machine. In this case, pre-adjustment of the machine data also takes place synchronously in the folding module 12. For example, the folding module 12 is automatically adapted to different format sizes or thicknesses of the material to be printed, wherein previously stored data can be retrieved for processing repeat orders.

An exemplary mode of operation of the invention is described below:

The sheets conveyed by the sheet conveyor system 5 pass through the dryer system 21 (and, if so required, a powdering station) in the conveying direction 2 and are transported to and deposited on a first delivery stack 9. In this case, the gripper systems of the driven drum 7 are inactive.

When the gripper systems of the drum 7 are selectively activated, the sheets can be transferred to the second stacking system 8 in the rotational direction 10 of the drum 7. This operating mode can be realized, for example, when waste sheets or sheets of reduced quality are produced, when test sheets are withdrawn, and when a non-stop stack exchange needs to be performed (first delivery stack).

Alternatively, the sheets can be continuously or periodically transported to the downstream folding module 12 in the rotational direction 10 of the drum 7. If a periodic transport takes place, unfolded sheets can be transported, if so required, to the first delivery stack 9 or, alternatively, to the second stacking system 8.

If the drum 7 and the folding module 12 are activated, the individual sheets being introduced into the folding pocket 14 come in contact with the stop 15 that can be adjusted according to variable formats. Due to the still existing kinetic energy, the sheets respectively form a hanging-down buckle fold in the buckle-folding chamber 17, with the buckle folds being individually taken hold of by the folding rollers 18, 19, so that the sheets are successively pulled through the gap between the folding rollers 18, 19 and a first fold is produced in the sheet. The sheets provided with the first fold are transported, if so required, to downstream folding apparatuses 13 and subsequently delivered.

1-9. (canceled)

10. A delivery unit for a sheet-fed processing machine comprising:
an endless sheet conveying system for conveying sheets to a first delivery stack;
a sheet removal drum that functions as a diverter upstream of the first delivery stack relative to the sheet conveying direction, the sheet removal drum including at least one gripper system and being associated with a lower track of the sheet conveying system;
a second sheet stacking system associated with the sheet removal drum;
a sheet guiding device arranged in proximity to the lower track of the sheet conveying system for transferring sheets to the second sheet stacking system, the sheet guiding device including a recess that extends over a predetermined format width;
a sheet transport system arranged downstream of the sheet removal drum in the direction of rotation of the sheet removal drum; and
a folding module including at least one folding apparatus arranged downstream of the sheet transport system.

11. The delivery unit according to claim 10 further including a guide element that is arranged parallel to a rotational axis of the sheet removal drum between the sheet removal drum and the sheet transport system.

12. The sheet delivery unit according to claim 11 wherein the guide element includes comb-shaped tines that extend in the direction of an outer surface of the sheet removal drum and form a guide surface.

13. The sheet delivery unit according to claim 11 wherein a front part of the guide element is tapered in the direction of the sheet removal drum.

14. The sheet delivery unit according to claim 10 wherein the folding apparatus is configured according to the buckle fold principle.

15. The sheet delivery unit according to claim 10 wherein the folding apparatus is configured according to the knife fold principle.

16. The sheet delivery unit according to claim 10 wherein the folding apparatus includes an adjustable stop arranged underneath the sheet conveying system in the direction of an ascending delivery section of the sheet conveying system and wherein at least two folding rollers are supported in a buckle-folding chamber such that they can be driven in opposite directions.

17. The sheet delivery unit according to claim 16 wherein the stop is arranged in a folding pocket so as to be adjustable to different formats.

18. The sheet delivery unit according to claim 16 wherein the folding rollers extend over a maximum format width.

19. The sheet delivery unit according to claim 10 wherein the folding module is slidable laterally relative to the conveying direction of the sheets into and out of the delivery unit.
